(19) United States
(12) Patent Application Publication
(10) Pub. No.: US 2011/0112873 A1
(43) Pub. Date: May 12, 2011

(54) System and Method for Electronically Monitoring, Alerting, and Evaluating Changes in a Health Care Payor Policy

(75) Inventors: Sheila Allen, San Antonio, TX (US); Craig Halley, Cedar Park, TX (US); Michael Kallish, Tampa, FL (US); Dean Skonieczny, Austin, TX (US)

(73) Assignee: MEDICAL PRESENT VALUE, INC., Austin, TX (US)

(21) Appl. No.: 12/944,375

(22) Filed: Nov. 11, 2010

Related U.S. Application Data
(60) Provisional application No. 61/260,074, filed on Nov. 11, 2009.

(51) Int. Cl. G06Q 40/00

(52) U.S. Cl. 705/4

(57) ABSTRACT

In one or more embodiments, a contract management system provides an alert sub-utility that includes web-based data mining tools to automatically detect changes to a carrier's website and a notification sub-utility for packaging and communicating these changes. These data mining tools parse through XML tags nested within a tree of the carrier's website and determine whether any changes have been made to the web document. These XML tags allow the data mining tool to focus its efforts in extracting particular data of interest. Once the changes of interest have been extracted, the notification sub-utility of one or more embodiments of the present invention creates and communicates an alert to the healthcare provider. The methods and systems of one or more preferred embodiments provide healthcare providers with a more focused and timely alert of changes to a carrier's policy. Further, they provide the health care provider with historical revenue data in combination with the policy change alerts.

### PRIORITY CLAIM

Benefit of priority under 35 USC §119(e) is claimed based on U.S. Provisional Application No. 61/260,074, entitled, “System and Method for Electronically Monitoring, Alerting, and Evaluating Changes to a Healthcare Payor Policy,” filed on Nov. 11, 2010, the entirety of which is incorporated herein by reference.

### BACKGROUND OF THE INVENTION

1. Field of the Invention

The illustrative embodiments relate generally to management of changes to a healthcare payor policy, and more particularly to a system and method of electronically monitoring, alerting, and evaluating changes to a healthcare payor policy.

2. Description of the Related Art

Medical bills are usually generated as a result of treatment, equipment or medicine received by a patient from a healthcare provider. The healthcare provider, such as a hospital or doctor's office, submits a claim to the insurer, health maintenance organization (HMO), government claims administrator (for example, the Medicare program) or other contractually obligated payor (hereinafter the “carrier”) on behalf of the patient seeking payment for the services rendered. The carrier pays for the services within the claim based on its contractual obligations to both the patient and healthcare provider. The payments may be pre-determined amounts for specific procedures or pre-determined percentages of the amount submitted to the carrier or calculated based on some other pre-determined formula.

The cost of healthcare continues to increase as the healthcare industry becomes more complex, specialized, and sophisticated. This complexity and specialization has created large administrative systems that coordinate the delivery of healthcare between healthcare providers, administrators, patients, and carriers. Although beneficial in some respects, the administrative system has increased the overall cost of healthcare, while, at the same time, making it difficult for healthcare providers to receive rapid payment for services rendered.

There are several reasons to account for the detrimental effect that large administrative systems have had on the quick payment of claims for healthcare services. For example, a single carrier may receive tens of thousands of payment requests each day and tens of millions of requests a year. The sheer volume of payment requests alone creates a backlog of unpaid claims. Additionally, the contractual obligations between healthcare providers, administrators, patients, and carriers are complex and may change frequently (e.g., weekly or even daily), further slowing the payment process. Carriers rarely notify the healthcare provider directly of these changes. In many cases, the healthcare provider is contractually responsible for monitoring each individual carrier's website for policy changes. In this regard, it should be noted that a healthcare provider may have a considerable number of different carriers (e.g. average of thirty-five (35)) with whom they conduct business.

Studies have shown that some insurance claims submission systems reject up to seventy percent of claims on their first submission for including inaccurate or incorrect information or for other reasons. Many of the claims are eventually paid, but only after they have been revised in response to rejections. In other instances, insurance claims are not paid because of patient ineligibility, claims made on diagnosis and treatments that are not eligible for payment (e.g., changes in procedure codes) and for other mechanical or legal reasons. This complication of the healthcare payment system in combination with the multiple cycles required to correct errors in the submission process continues to decrease the efficiency of the healthcare system and substantially increase the time and expense it takes to process a claim.

During recent years, the payment of healthcare services has been expedited by automating the process for creating, receiving, and adjudicating payment requests. For example, there currently exists practice management systems whereby healthcare providers (or their agents) electronically create and submit medical insurance claims to a central processing system. However, even using these automated systems, it is difficult to determine whether the claim is in condition for payment. For example, it has been found that a large number of insurance claims are submitted with information that is incomplete, incorrect/outdated, or that describes diagnoses and treatments that are no longer eligible for payment. The healthcare provider, however, is not made aware of the deficiencies of the submitted claims until a later date, potentially weeks afterwards, when the disposition of the insurance claim is communicated to the healthcare provider. As a result, many claims are subject to multiple submissions and adjudication cycles as they are created, rejected and amended.

The resulting delays in receiving payment for patient treatment have created cash flow problems for healthcare providers. For example, each denial of payment costs the healthcare provider an average of $35 per claim. Moreover, reimbursement delays have been particularly detrimental to healthcare providers who purchase specialized equipment and hire experienced staff in order to provide specialized testing and diagnostics of patient conditions. Given the high expense of such complex medical diagnostic or testing equipment, medical providers often finance such capital purchases through loans or leases. Given the significant time lag of sometimes up to sixty days between the time services are rendered to a patient and when payment from the carrier is received for those services, the healthcare provider is forced to carry the significant financial cost of this equipment, as well as the other capital expenditures, overhead and operational costs of the specialized medical testing services during the delay. In order to resolve these financial issues, healthcare providers typically maintain sufficient cash or credit to cover the cash flow demands needed to meet its financial obligations.

In view of the foregoing, there is a need in the art to avoid many of the above problems and provide healthcare providers with better information regarding changes to a healthcare payor policy.

### BRIEF DESCRIPTION OF THE DRAWINGS

This invention is described in a preferred embodiment in the following description with reference to the drawings, in which like numbers represent the same or similar elements, as follows:

FIG. 1 is a block diagram representation showing an exemplary carrier-contract manager-subscriber framework;

FIG. 2 is a block diagram representation of a data processing system to carry out the various features of the invention, in accordance with one embodiment of the invention;

FIGS. 3A-3B represent individual parts of a high level logical flowchart of an exemplary process for electronically monitoring, analyzing, and communicating policy changes to a carrier's website, in accordance with one or more embodiments of the present invention.

FIG. 4 shows an exemplary data sheet of a policy change alert, in accordance with one embodiment of the invention.

### DETAILED DESCRIPTION OF PREFERRED EMBODIMENTS

According to one or more preferred embodiments, an alert system includes a web-based data mining sub-utility for automatically detecting changes to a carrier's website and a notification sub-utility for packaging and communicating these changes. The web-based data mining sub-utility parses through a carrier's website and determines, using a comparator module, whether any changes have been made to web documents and identifies changes in carrier policies. The data mining sub-utility logs changes of interest by identifying XML tags embedded in the webpage document, and associating data of interest shown on a carrier's website with the corresponding XML tags. When the changes of interest have been identified, the web-based data mining sub-utility extracts and determines the name of the payor, the text of the policy change, the hyperlink location of the policy change, the category of alert that the change of interest falls under, the medical specialty associated with the policy change, and the effective date of the policy change. A policy analysis sub-utility cross-references the extracted policy change data associated with a particular diagnosis and/or procedure code with previously mined historical claims data associated with the same diagnosis and/or procedure code and stored in a historical database. The policy analysis sub-utility forecasts the economic effects of the extracted policy change based on its extrapolation of the historical claims data associated with the particular healthcare provider. The extracted results from the data mining sub-utility and the forecast data from the policy analysis sub-utility are submitted to the notification sub-utility, which creates and communicates a customized alert to the healthcare provider by using the extracted results and forecast data.

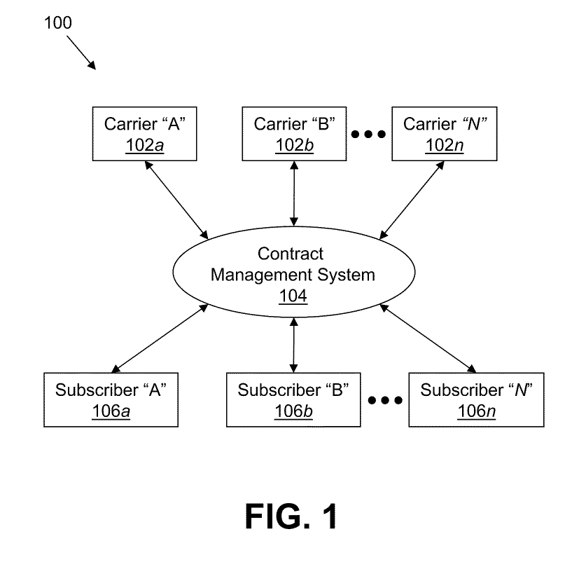

With reference now to FIG. 1, there is shown a block diagram of an exemplary alerting framework 100 between one or more carriers 102a-102n, contract management system 104, and one or more healthcare subscriber(s) 106a-106n. To improve the efficiency of billing to an insurance carrier, each healthcare subscriber (e.g., medical doctor, hospital) 106a-106n subscribes to contract management system 104. Contract management system 104 is responsible for alerting its healthcare subscriber(s) of any carrier policy changes that are published at a website of carrier(s) 102a-102n and that fall within a category and medical specialty for which the applicable healthcare subscriber has previously specified. In one or more embodiments, contract management system 104 is also responsible for the electronic auditing and adjudication of claims by healthcare subscriber 106a-106n to carrier 102a-102n. In contrast to practice management systems, contract management systems do not need to be responsible for the electronic creation and submission of claims by healthcare subscribers to carriers, but in some embodiments can include such functionality.

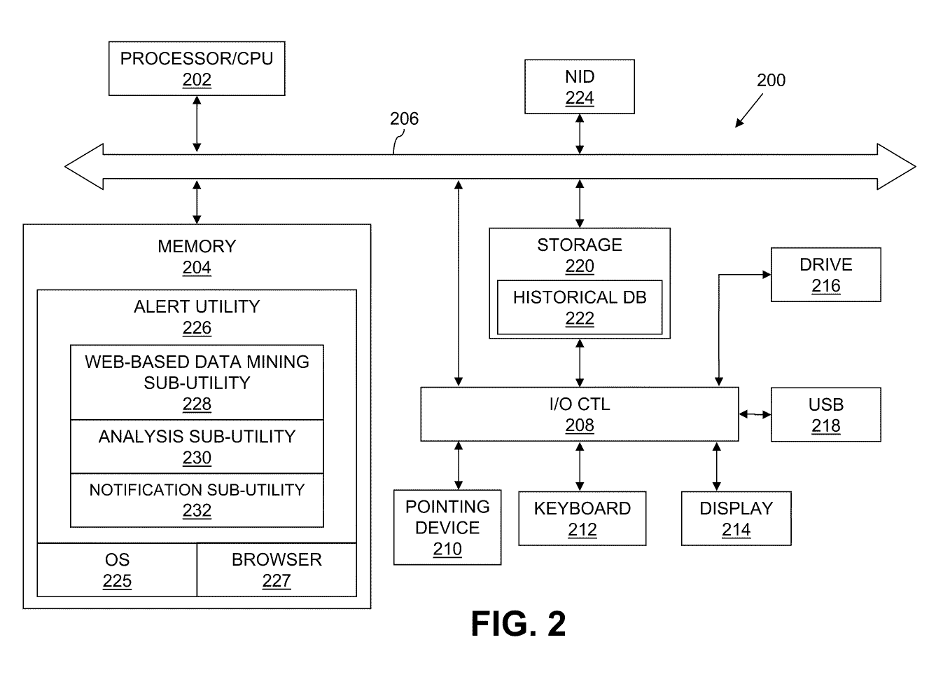

With reference to FIG. 2, there is depicted a block diagram representation of an exemplary data processing system (DPS) 200 used by contract management system 104 (FIG. 1) for implementing the various features of one or more preferred embodiments. As shown, data processing system (DPS) 200 comprises one or more processors or central processing units (CPU) 202 connected to memory 204 via system interconnect/bus 206. Also connected to system/interconnect bus 206 is I/O controller 208, which provides connectivity and control for input devices, of which pointing device (or mouse) 210 and keyboard 212 are shown, and output device, of which display 214 is shown. Additionally, a multimedia drive 216 (e.g., CDRW or DVD drive) and USB (universal serial bus) port 218 are illustrated, coupled to I/O controller 208. Multimedia drive 216 and USB port 218 may operate as both input and output mechanisms. DPS 200 also comprises storage 220, within which data from historical database 222 is utilized to extrapolate revenue projections based on a carrier's publication of its policy change(s) (described below).

DPS 200 is also illustrated with a network interface device (NID) 224 with which DPS 200 connects to another computer device (e.g., a carrier's web server) or computer network. NID 224 may comprise a modem and/or a network adapter, for example, depending on the type of network and connection method to the network. It is however understood that application of the various processes of the invention may occur within a DPS 200 that is not connected to an external network, but receives the input data (e.g., carrier's web pages in HTML format) via some other input means, such as a CD/DVD medium within multimedia drive 216, a thumb/flash drive inserted in USB port 218, user input via keyboard 212, or other input mechanisms/methods.

Those of ordinary skill in the art will appreciate that the hardware depicted in FIG. 2 is a basic illustration of a data processing system and may vary. Thus, the depicted example is not meant to imply architectural limitations with respect to the preferred embodiments.

Notably, in addition to the above described hardware components of DPS 200, various features of the preferred embodiments are provided as software/firmware code stored within memory 204 or other storage (e.g., storage 220) and executed by CPU 202. Thus, located within memory 204 and executed on CPU 202 are a number of software components, including operating system (OS) 225 (e.g., Microsoft Windows®, a trademark of Microsoft Corp, or GNU®/Linux®, registered trademarks of the Free Software Foundation and The Linux Mark Institute), browser 227 and other software applications, of which Alert utility 226 is shown. CPU 202 executes Alert utility 226 as well as OS 225 and browser 227, which supports the execution of Alert utility 226. In actual implementation, Alert utility 226 may be loaded on and executed by any existing computer system to provide real-time (or analyst-directed) electronic monitoring, analysis/forecasting, and alerts of changes to a carrier's policy, as further described below. Alert utility 226 also includes several sub-utilities (web-based data mining sub-utility 228, analysis sub-utility 230, and notification sub-utility 232) for completing the entire range of functions, as described herein.

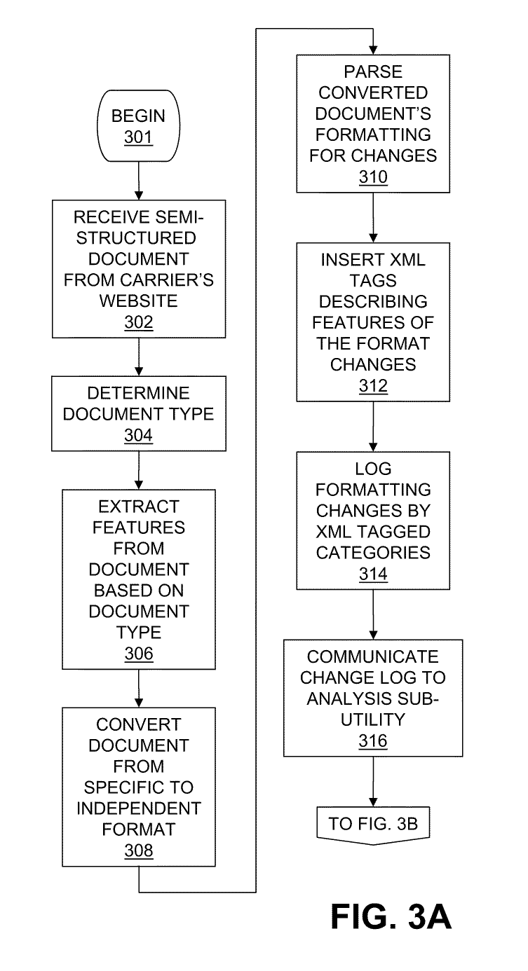

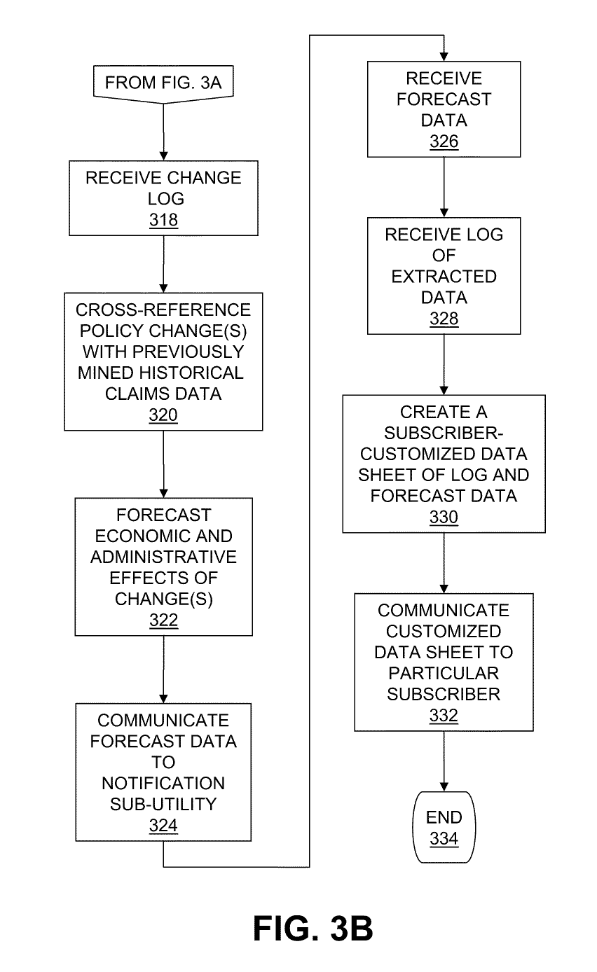

With reference now to FIG. 3A, there is shown a partial section of a flow diagram 300 of a process utilizing web-based data mining sub-utility 228 (FIG. 2) for electronically monitoring policy changes to a carrier's website, in accordance with one embodiment of the preferred embodiments. Process 300 begins at block 301 and continues to block 302, which depicts contract management system 104 requesting and receiving via browser 227 a semi-structured document from a carrier's 102 website. In one embodiment, a semi-structured document is a Web document downloaded from a carrier's 102 website. However, the preferred embodiments are not limited to documents coming from a particular information medium, and in some embodiments, for example, may be a document in a Hyper Text Markup Language (HTML), Portable Document Format (PDF), or some other standard document format. While these mentioned formats are specifically recited in the embodiment, the preferred embodiments can be adapted to work with other document formats as well.

A semi-structured document contains information that has more structural features than simple free text. Structured information can be presented in tables, lists, sections, bullet lists, numbered sections, multi-level structures, and the like. An example of a semi-structured document is a carrier's Web page in HTML, which could include section headings, text sections, and tables containing carrier policy data.

With reference to step 304 of FIG. 3A, a logic operation in data mining utility 228 takes place to determine the document type and directs the received document to a feature extractor that is specific to the document's type. For example, if the document is an HTML document, the document is sent to an HTML feature extractor, and if the document is a PDF document, the document is sent to a PDF feature extractor. It should be noted that one or more preferred embodiments can also incorporate additional feature extractors for other document formats. At step 306, the feature extractor corresponding to the document's type then extracts features from the received document. At step 308, the feature extractor converts the extracted document, including its document format, from a specific format (e.g., HTML, PDF, etc.) to an independent format for easier analysis of the data contained in the received document. In one embodiment, the independent format is the Extensible Markup Language (XML).

At step 310, Web-based data mining sub-utility 228 parses the converted document for formatting changes when compared to previously downloaded versions of the particular document. XML is used to present structured data such as a database in a text format. Like HTML, XML makes use of tags and attributes. However, while HTML specifies what each tag and attribute means, XML uses the tags to delimit data and leaves the interpretation of the data up to the application that reads it. At step 312, data mining sub-utility 228 appends XML tags to the received document as the document is parsed. The XML tags are used to describe features of the received document's structure and provide a higher level of understanding about the document structure than can be derived from the formatting information alone. Moreover, the XML tags facilitate data mining the document at a later date for subsequent policy changes at the carrier's website. Examples of features of the received document that the web-based data mining sub-utility may tag can include (i) font size data, (ii) x,y coordinate information (e.g., spacing information, layout of lines, characters, and word clusters) for text in the received document (e.g., PDF document), and (iii) data that describes/categorizes text within the received document (e.g., the text of the policy change, the medical specialty associated with the policy change, and the effective date of the policy change, hyperlink strings, diagnosis codes, procedure codes, etc.). At step 316, the data mining sub-utility 228 logs the formatting changes in the received document in a document change log. In this regard, the logged data is stored according to its XML-tagged categories. In one or more embodiments, the data of interest on the carrier's website is the carrier's policy terms, conditions, procedures, requirements, payment schedules, etc. When the logged data are changes to a carrier's posted policies, the corresponding document change log is referred to as a policy change log. At step 316, the logged data identifying changes to the document is communicated to analysis sub-utility 230, whose functionality is described in FIG. 3B.

With reference now to step 318 of FIG. 3B, analysis sub-utility 230 (FIG. 2) receives the document change log. As depicted in step 320, analysis sub-utility 230 cross-references the document change log with previously mined historical data, for example claims data, stored in historical database 222 (FIG. 2). In this regard, analysis sub-utility 230 harvests the previously mined historical claims data for a particular type of claim associated with a policy change log.

At step 322, analysis sub-utility 230 forecasts what the economic and/or administrative effect(s) on the subscriber(s) will be given the identified change in the document change log. For example, the policy change log may contain information that relates to what amount of compensation the carrier will pay a healthcare provider/subscriber for performing a particular medical procedure. Such procedures are identified using Current Procedural Terminology (CPT) codes. CPT codes are numbers assigned to every task and service a healthcare provider may provide to a patient including medical, surgical and diagnostic services. They are then used by insurance carriers to determine the amount of reimbursement that a practitioner will receive by a carrier. Since all carriers have adopted the same codes to have the same meaning, CPT codes ensure uniformity throughout the industry. Continuing with the example, assume that CPT code 90801, which represents “Bariatric Surgery,” has been removed from coverage by the carrier. When CPT code 90801 is cross-referenced with a particular healthcare subscriber's historical claims data pertaining to CPT code 90801, analysis sub-utility 230 determines that the healthcare subscriber had performed that procedure three hundred times in the previous year at a billed unit cost of $3,000. Analysis sub-utility 230 forecasts (block 322) that the above policy change would translate to a forecasted loss of $900,000 over the next twelve-month period, which commences at the effective date of the policy change. It should be noted that preferred embodiments are not limited to forecasting financial data. Moreover, other types of forecast data can be drawn from the logged document changes, such as forecasting administrative or logistical data. Moreover, one or more preferred embodiments can monitor other types of codes, such as Healthcare Common Procedure Coding System (HCPCS) codes and International Statistical Classifications of Diseases (ICD) diagnosis codes. At step 324, analysis sub-utility communicates the forecast data to notification sub-utility 232 (FIG. 2).

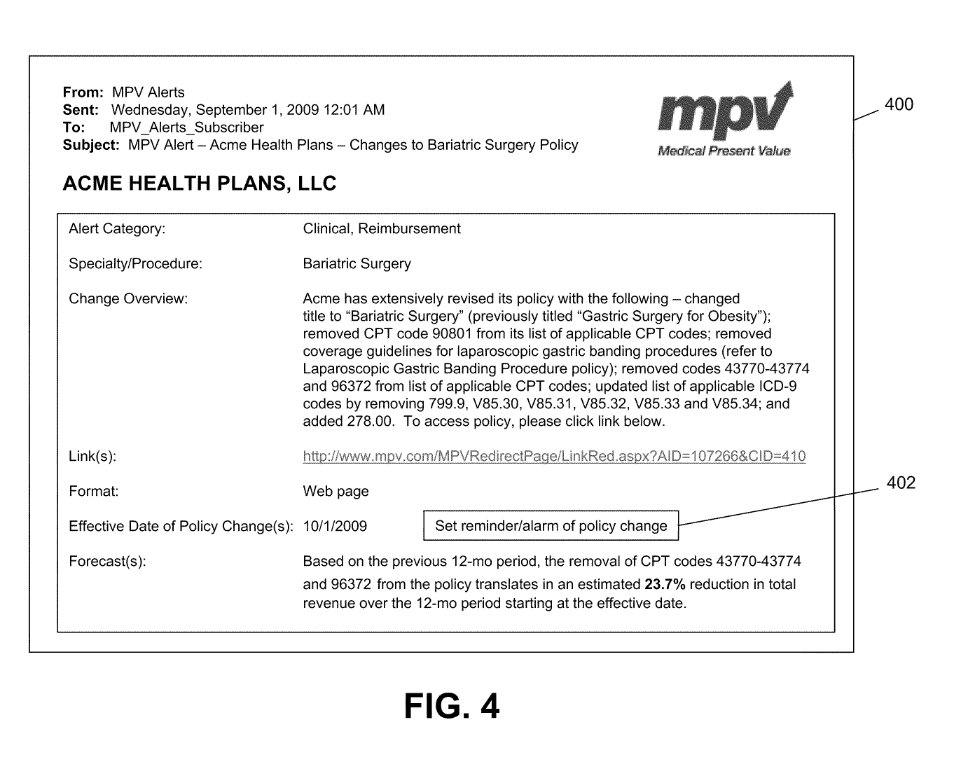

Notification sub-utility 232 receives the forecast data at step 326, as well as a log of the extracted data at step 328. Notification sub-utility 232 creates a subscriber-customized data sheet 400 (FIG. 4) using the extracted log data and forecast data, as depicted in step 330. From block 330, the process continues to block 332, which depicts notification sub-utility communicating customized data sheet 400 via e-mail. It should be noted that other forms of electronic communication can be used, such as Short Message Service (SMS), Extended Message Service (EMS), Multimedia Messaging Service (MMS), etc., for example. From block 330, the process ends at termination block 334.

With reference to FIG. 4, an exemplary data sheet 400 is shown. Exemplary data sheet 400 contains various policy change information pertaining to a particular healthcare subscriber. Such information includes, but is not limited to: (a) the name of the carrier in question; (b) an alert category (e.g., “Clinical”, “Administrative”, “Reimbursement”, and/or “Pharmaceutical”); (c) a medical specialty/procedure (e.g., “Bariatric Surgery”); (d) an overview of the carrier's policy change; (e) a hyperlink location of the actual carrier's policy change; (f) an effective date of the policy change(s); and (g) a revenue/administrative forecast in view of the new policy change and the subscriber's historical claims data. Moreover, the data sheet displays a calendar button 402, which allows the particular recipient of the alert to set a reminder/alarm (e.g., interfaced with a calendar utility) to remind the recipient subscriber of the prospective change in the carrier's policy.

While notification sub-utility 232 has been described above in a “push” approach, whereby the information is automatically harvested and “pushed” via an alert to a recipient (e.g., healthcare subscriber 106a-106n), other communication approaches can be implemented. According to other preferred embodiments, notification sub-utility 232 adopts a “pull” approach, whereby healthcare subscriber 106a-106n is able to: (i) access current carrier website document data such as claims and policy data, (ii) access historical claims data and policy data related to the accessed carrier website, and (ii) run reports and forecasts using such accessed data via a graphical user interface (GUI). Exemplary reports and/or forecasts may include, for example: (a) earnings reports during a particular time period, (b) forecasts of prospective earnings for a prospective time period, and (c) efficiency reports that detail the reimbursement and/or procedural efficiency for varying periods within the claims process. Such reports/forecast data can be further filtered by carrier/payor, medical procedure, and policy change categories. Moreover, notification sub-utility 232 may be configured to allow healthcare subscriber 106a-106n to generate side-by-side comparisons of the various carrier policies in terms of the carriers' reimbursement efficiencies (e.g., how much of the amount claimed is allowed by the carrier) and procedural efficiencies (e.g., how long does it take to resolve a claim; number of denial cycles before resolution of a claim).

As will be appreciated by those skilled in the art, the contract management system provided by one or more preferred embodiments of the present invention incorporates an alert sub-utility that includes web-based data mining tools to automatically detect changes to a carrier's website and a notification sub-utility for packaging and communicating these changes. These data mining tools parse through XML tags nested within a tree of the carrier's website and determine whether any changes have been made to the web document. These XML tags allow the data mining tool to focus its efforts in extracting particular data of interest. Once the changes of interest have been extracted, the notification sub-utility of one or more embodiments of the present invention creates and communicates an alert to the healthcare provider. The methods and systems of the preferred embodiments provide healthcare providers with a more focused and timely alert of changes to a carrier's policy. Further, they provide the health care provider with historical revenue data in combination with the policy change alerts. The alert systems of the various preferred embodiments allow the healthcare provider to make better informed decisions regarding their continued contractual arrangement with a particular carrier, as well as reduce the risk that a claim won't be paid because of errors in the claim form, errors in the administrative process or changes in contractual arrangements.

While the invention has been particularly shown and described with reference to one or more preferred embodiments, it will be understood by those skilled in the art that various changes in form and detail may be made therein without departing from the spirit and scope of the invention.

What is claimed is:

1. A method comprising:
receiving document data from a carrier website, wherein the document data is associated with a carrier policy;
extracting carrier policy features of the document data related to the carrier policy;
determining extracted carrier policy features of the document data that have changed from extracted carrier policy features of previously received versions of the document data from the carrier website;
forecasting one or more effects on one or more healthcare providers that will result from the determined changed carrier policy features; and
communicating at least one of the one or more effects of changed carrier policy features to at least one of the one or more healthcare providers.

2. The method of claim 1, further comprising:
determining a document format for the document data from the carrier website;
and wherein the step of extracting features of the document related to the carrier policy further comprises extracting features of the document related to the carrier policy based on the determined document format.

3. The method of claim 2, further comprising:
converting the document data from the document format to an independent format; and
wherein the step of parsing the document data comprises parsing the converted document data.

4. The method of claim 3, wherein the independent format is Extensible Markup Language (XML).

5. The method of claim 3, further comprising:
inserting tags in the converted document data describing features that have changed.

6. The method of claim 5, further comprising:
generating a log of the extracted carrier policy features determined to have changed, wherein the changed features of the carrier website within the log are categorizing based on the inserted tags in the converted document data.

7. The method of claim 1, further comprising:
automatically detecting changes occurring to the carrier website and retrieving these changes within the received document data in response to detecting the changes.

8. The method of claim 1, wherein forecasting one or more effects on one or more healthcare providers that will result from the determined changed carrier policy features includes forecasting one or more economic effects on one or more healthcare providers resulting from a change in carrier policy associated with the determined changed carrier policy features.

9. The method of claim 1, wherein communicating at least one of the one or more effects of the changed carrier policy features to at least one of the one or more healthcare providers includes communicating the at least one of the one or more effects via an email message.

10. The method of claim 1, wherein communicating at least one of the one or more effects of the changed carrier policy features to at least one of the one or more healthcare providers includes communicating the at least one of the one or more effects via a Short Message Service message.

11. The method of claim 1, wherein communicating at least one of the one or more effects of the changed carrier policy features to at least one of the one or more healthcare providers includes communicating the at least one of the one or more effects via a message containing a user input generating a reminder for a user of one or more changed carrier policy features associated with the at least one of the one or more effects.

12. The method of claim 1, wherein the document data is in Hyper Text Markup Language (HTML).

13. A system, comprising:
a data mining utility that automatically detects changes to a carrier's website, parses through the carrier's website and determines, using a comparator module, whether any changes have been made to web documents and identifies and logs changes in carrier policies that are changes of interest, wherein a change of interest is determined by identifying tags embedded in the webpage document;
a policy analysis utility that cross-references the extracted policy change data associated with a particular diagnosis and/or procedure code with previous claims data associated with the particular diagnosis and/or procedure code stored in a historical database coupled to the policy analysis utility, and wherein the policy analysis utility generates a forecast of the effects of the extracted policy change based on extrapolation of the historical claims data; and
a notification utility that packages and communicates the extracted results from the data mining utility and the forecast data from the policy analysis utility in a customized alert to one or more healthcare providers.

14. The system of claim 13, further comprising:
wherein the data mining utility extracts and determines one or more information from among: a name of a payor, a text of a policy change, a hyperlink location of a policy change, a category of alert that a change of interest falls under, a medical specialty associated with a policy change, and an effective date of a policy change.

15. A system, comprising:
a processor; and
a memory medium coupled to the processor;
wherein the memory medium includes instructions, which when executed by the processor, cause the system to perform:
receiving document data from a carrier website, wherein the document data is associated with a carrier policy;
extracting carrier policy features of the document data related to the carrier policy;
determining extracted carrier policy features of the document data that have changed from extracted carrier policy features of previously received versions of the document data from the carrier website;
forecasting one or more effects on one or more healthcare providers that will result from the determined changed carrier policy features; and
communicating at least one of the one or more effects of changed carrier policy features to at least one of the one or more healthcare providers.

16. The system of claim 15, further comprising:
a document formatting utility that determines a document format for the document data from the carrier website; and extracts features of the document related to the carrier policy based on the determined document format.

17. The system of claim 15, further comprising:
a conversion utility that converts the document data from the document format to an independent format; and
wherein the step of parsing the document data comprises parsing the converted document data.

18. The system of claim 15, further comprising:
a log generation utility that generates a log of the extracted carrier policy features determined to have changed, wherein the changed features of the carrier website within the log are categorizing based on tags in the document data.

19. The system of claim 15, further comprising:
a detection utility that automatically detects changes occurring to the carrier website and retrieving these changes within the received document data in response to detecting the changes.

20. The system of claim 15, further comprising:
a forecasting utility that forecasts one or more effects on one or more healthcare providers that will result from the determined changed carrier policy features, including forecasting one or more economic effects on one or more healthcare providers resulting from a change in carrier policy associated with the determined changed carrier policy features.

21. A computer readable memory medium comprising instructions, which when executed on a processing system, cause the processing system to perform:
receiving document data from a carrier website, wherein the document data is associated with a carrier policy;
extracting carrier policy features of the document data related to the carrier policy;
determining extracted carrier policy features of the document data that have changed from extracted carrier policy features of previously received versions of the document data from the carrier website;
forecasting one or more effects on one or more healthcare providers that will result from the determined changed carrier policy features; and
communicating at least one of the one or more effects of changed carrier policy features to at least one of the one or more healthcare providers.

22. The computer readable memory medium of claim 21, further comprising:
determining a document format for the document data from the carrier website; and
wherein the step of extracting features of the document related to the carrier policy further comprises extracting features of the document related to the carrier policy based on the determined document format.

23. The computer readable memory medium of claim 22, further comprising:
converting the document data from the document format to an independent format; and wherein the step of parsing the document data comprises parsing the converted document data.

24. The computer readable memory medium of claim 23, further comprising:
wherein the independent format is Extensible Markup Language (XML).

25. The computer readable memory medium of claim 23, further comprising:
inserting tags in the converted document data describing features that have changed.

26. The computer readable memory medium of claim 25, further comprising:
generating a log of the extracted carrier policy features determined to have changed, wherein the changed features of the carrier website within the log are categorizing based on the inserted tags in the converted document data.

27. The computer readable memory medium of claim 21, further comprising:
automatically detecting changes occurring to the carrier website and retrieving these changes within the received document data in response to detecting the changes.

28. The computer readable memory medium of claim 21, wherein forecasting one or more effects on one or more healthcare providers that will result from the determined changed carrier policy features includes forecasting one or more economic effects on one or more healthcare providers resulting from a change in carrier policy associated with the determined changed carrier policy features.

29. The computer readable memory medium of claim 21, further wherein communicating at least one of the one or more effects of the changed carrier policy features to at least one of the one or more healthcare providers includes communicating the at least one of the one or more effects via an email message.

30. The computer readable memory medium of claim 21, further comprising: wherein communicating at least one of the one or more effects of the changed carrier policy features to at least one of the one or more healthcare providers includes communicating the at least one of the one or more effects via a message containing a user input generating a reminder for a user of one or more changed carrier policy features associated with the at least one of the one or more effects.

31. The computer readable memory medium of claim 21, wherein the document data is in Hyper Text Markup Language (HTML).
